(19) United States
(12) Patent Application Publication
(10) Pub. No.: US 2005/0162733 A1
(43) Pub. Date: Jul. 28, 2005

(54) Method of fabricating diffractive lens array and UV dispenser used therein

(75) Inventors: Eun-hyoung Cho, Seoul (KR); Myung-bok Lee, Suwon-si (KR); Jin-seung Sohn, Seoul (KR); Mee-suk Jung, Suwon-si (KR); Hae-sung Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/003,353

(22) Filed: Dec. 6, 2004

(30) Foreign Application Priority Data
Dec. 6, 2003 (KR) 10-2003-0088414

(51) Int. Cl. G02B 5/20

(52) U.S. Cl. 359/361; 359/558

(57) ABSTRACT

A method of fabricating a diffractive lens array mold and an ultraviolet (UV) dispenser for use in the same. The method includes the steps of (a) fabricating a single or array diffractive lens mold using a nickel (Ni) shim; (b) fabricating a first diffractive lens array mold using an ultraviolet (UV) dispenser including the single diffractive lens mold; and (c) fabricating a second diffractive lens array mold having an inverted profile of the first diffractive lens array mold.

This application claims the priority of Korean Patent Application No. 2003-88414, filed on Dec. 6, 2003, in the Korean Intellectual Property Office, the disclosure of which is incorporated herein in its entirety by reference.

### BACKGROUND OF THE INVENTION

1. Field of the Invention

The present invention relates to a process for fabricating a diffractive lens array mold and an ultraviolet (UV) dispenser, and more particularly, to a method of fabricating a diffractive lens array mold using a UV embossing process that significantly reduces alignment error and a UV dispenser used during fabrication of the diffractive lens array mold.

2. Description of the Related Art

Replication techniques such as hot embossing, molding or casting and transfer of a microstructure are used for mass production of diffractive optical elements (DOEs) or micro-optical elements with patterns of micron- and nanometer-scale dimensions. Hot embossing or injection molding is employed in a replication process of sub-micron grating structures or CD or DVD media. However, there is a need for development of improved techniques for replicating microstructures such as refractive micro-lens arrays and diffractive micro-lens arrays with deeper and smaller patterns.

A typical replication process involves patterning a master mold by high-resolution lithography, replicating the masters by nickel (Ni) electroplating, and forming a Ni shim array by arranging the replicated structures in an array for high volume manufacture. Then, to fabricate molds from the master mold, an array of micro-patterns is transferred onto a thermoplastic or UV curable polymer using various replication techniques.

In general, lithography and direct machining are mainly used in fabrication of microstructures with fine patterns. Direct machining offers advantages such as rapid processing and analog surface machining. However, due to less accuracy in fabricating micropatterns and the difficulty in fabricating asymmetric complex patterns, lithography is more prevalently used in fabrication of DOEs on which microstructures have been patterned than direct machining. In particular, an electron beam lithography (EBL) technique is useful in fabricating ultra-precise patterns. However, expensive EBL equipment and long processing times make it impossible to fabricate a DOE array with patterned microstructures.

Fabrication of a DOE array includes precisely fabricating a master mold using a lithographic technique such as EBL, replicating a plurality of Ni shims by Ni electroplating and fabricating a Ni shim array with DOEs by arranging the plurality of replicated Ni shims in an array. Replication by Ni electroplating shows almost perfect transferability but suffers from a geometrical error between the replicated Ni shims that cannot be neglected. Furthermore, this procedure requires a long processing time and may cause a large alignment error when arranging individual Ni shims in an array. In particular, an alignment error experienced by a DOE optically has adverse effects on the performance of a hybrid refractive-diffractive lens. The hybrid refractive-diffractive lens with a compact structure offers excellent optical performance, and precise alignment of refractive and diffractive optical elements are of great concern in its fabrication.

To overcome the drawbacks of a conventional Ni electroplating process, a method of fabricating a Ni shim array using a hot embossing technique has been proposed. Referring to FIG. 1, a hot embossing tool 12 is spaced apart from a polymer sheet 11 by a predetermined distance and presses a desired unit element of a DOE array in order to form a Ni shim 13. Then, hot embossing is carried out on the Ni shim 13 to fabricate a diffractive lens array mold 14. However, the hot embossing approach poses limitations to the replication of DOEs on which microstructures have been patterned.

A UV embossing technique is receiving considerable attention as an alternative method of replication. To fabricate a diffractive lens array, the UV embossing process includes applying a UV curable polymer over a substrate such as glass by spin coating, pressing a prefabricated diffractive lens array mold onto the polymer, and irradiating the polymer with UV light to cure the polymer. The UV curable polymer should meet the following conditions. First, a high refractive index greater than about 1.5 and a light transmittance greater than about 95% are required. Second, the polymer should exhibit excellent adhesion to material such as glass. Third, the polymer should allow for easy demolding after curing. Fourth, the polymer should undergo a small variation in refractive index with temperature. Fifth, the polymer should be reactive with UV radiation or be UV-cured in a wavelength band from 200 to 300 nm.

The UV embossing technique offers excellent transferability in applying UV curable material over a glass substrate and patterning the same as compared with other replication techniques, thereby enabling accurate replication of high resolution microstructures.

### SUMMARY OF THE INVENTION

It is therefore an object of the present invention to provide a method of fabricating a diffractive lens array that eliminates alignment error while offering excellent productivity due to rapid processing, and an ultraviolet (UV) dispenser for use in fabricating the diffractive lens array.

The above object has been achieved, according to a first aspect of the present invention, by providing a method of fabricating a diffractive lens array mold including the steps of: (a) fabricating a single or array diffractive lens mold using a nickel (Ni) shim; (b) fabricating a first diffractive lens array mold using an ultraviolet (UV) dispenser including the single diffractive lens mold; and (c) fabricating a second diffractive lens array mold having an inverted profile of the first diffractive lens array mold. The step (a) includes: fabricating a master mold with a micropattern and an inverted profile of a diffractive lens by electron beam lithography; performing a Ni electroplating process on the master mold and forming a Ni shim with a diffractive lens pattern; and fabricating a single or array diffractive lens mold with an inverted profile of the Ni shim.

The fabrication of the single or array diffractive lens mold includes the steps of: applying a first UV curable polymer on a transparent film; pressing the Ni shim onto the first UV curable polymer; and irradiating the transparent film with UV light to cure the first UV curable polymer, separating the first UV curable polymer from the Ni shim, and forming the single or array diffractive lens mold.

The method may further include the step of heating the single diffractive lens mold to a predetermined temperature and performing an aging process at room temperature to improve adhesion between the single or array diffractive lens mold and the transparent film. The first UV curable polymer is applied over the transparent film by spin coating. The step (b) includes etching the surface of the Si substrate to form a plurality of grooves having a predetermined depth; applying a second UV curable polymer over the Si substrate; and pressing the UV dispenser including the single or array diffractive lens mold onto each of the plurality of grooves on the Si substrate, irradiating to cure the second UV curable polymer, and forming the first diffractive lens array mold.

The second UV curable polymer is applied over the Si substrate by spin coating. The method may further include the step of heating the first diffractive lens array mold to a predetermined temperature and performing an aging process at room temperature to improve adhesion between the Si substrate and the first diffractive lens array mold. The step (c) includes applying a third UV curable polymer on a transparent plate; and pressing the first diffractive lens array mold onto the third UV curable polymer, irradiating to cure the third UV curable polymer, and forming the second diffractive lens array mold.

The method may further include the step of heating the second diffractive lens array mold to a predetermined temperature and performing an aging process at room temperature to improve adhesion between the transparent film and the second diffractive lens array mold.

According to another aspect, the present invention provides an ultraviolet (UV) dispenser for use in a UV embossing process, which includes a UV resistant closed cover having an opening at a bottom and a UV-blocking housing on top, right, and left sides thereof; a UV light source disposed in an upper portion of the UV resistant closed cover; and a single or array diffractive lens mold mounted in the opening at the bottom of the UV resistant closed cover.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a process of fabricating a diffractive lens array using a conventional technique;

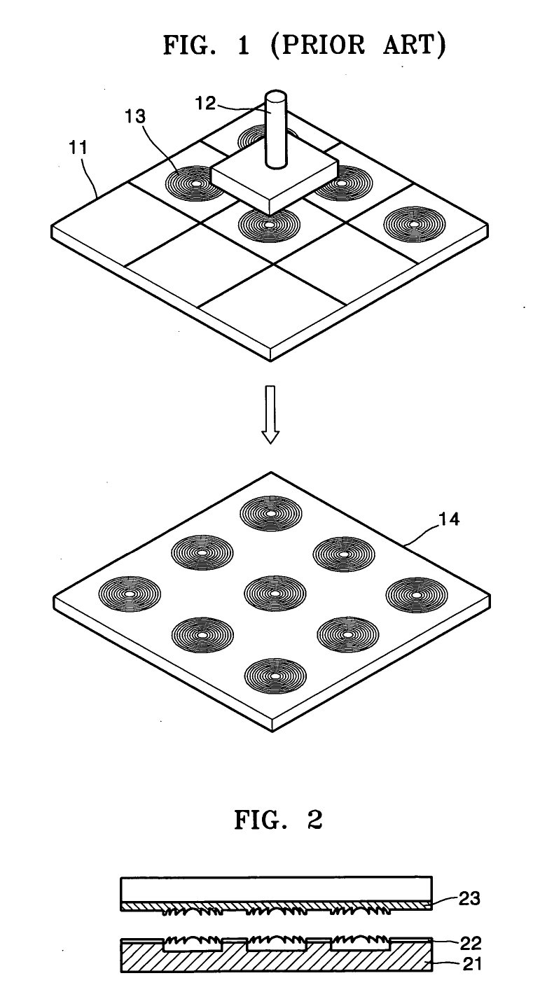

FIG. 2 illustrates a process of fabricating a diffractive lens array using a diffractive lens array mold manufactured according to an embodiment of the present invention;

FIGS. 3A-3D illustrate a process of fabricating a single diffractive lens mold for the manufacture of a diffractive lens array mold according to an embodiment of the present invention;

FIG. 4 shows an ultraviolet (UV) dispenser according to an embodiment of the present invention; and

FIGS. 5A-5H illustrate a process of fabricating a diffractive lens array mold according to an embodiment of the present invention.

### DETAILED DESCRIPTION OF THE INVENTION

The present invention is now described in further detail by reference to the drawings. However, the present invention should not be construed as being limited thereto.

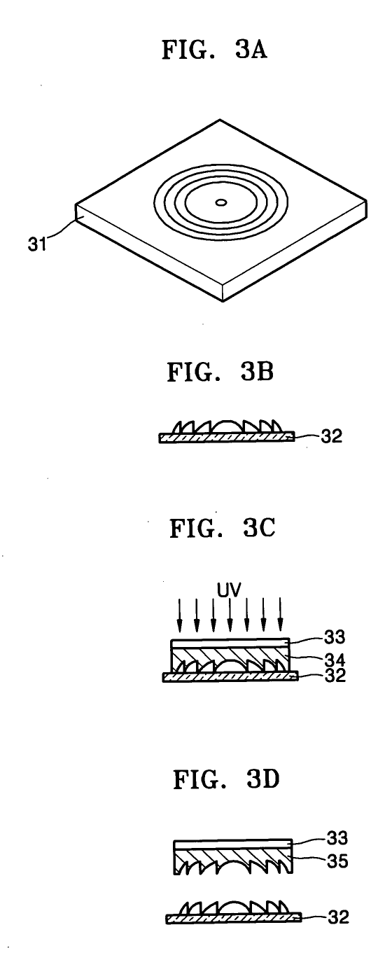

Referring to FIG. 2, a diffractive lens array 22 is fabricated by an ultraviolet (UV) embossing process. More specifically, a diffractive lens array mold 23 is pressed onto a glass substrate 21 on which a polymer has been coated. Then, the polymer is cured by UV radiation. The polymer is fully cured when heated to a predetermined temperature, thereby fabricating the diffractive lens array 22. A solution containing (Si, Ti)O₂ precursors may be used instead of the polymer and has characteristics similar to a glass material when cured by UV radiation. Since refractive index varies depending on the precursor, the use of the solution can improve optical performance. Forming a desired diffractive lens array and an inverted mold structure is essential to fabrication of the diffractive lens array 22.

A process of fabricating a diffractive lens array involves the following three steps. The first step is forming a unit diffractive lens master with a microscopic pattern by electron beam lithography (EBL), replicating the master by nickel (Ni) electroplating to form a single Ni shim and using the single Ni shim to fabricate a single or array diffractive lens mold composed of a polymer. The second step is fabricating a first diffractive lens array mold using a UV dispenser with the diffractive lens array mold. The third step is fabricating a second diffractive lens array mold containing an inverted profile using the first diffractive lens array mold. The diffractive lens array mold manufactured in this way is used to fabricate the diffractive lens array 22 as shown in FIG. 2.

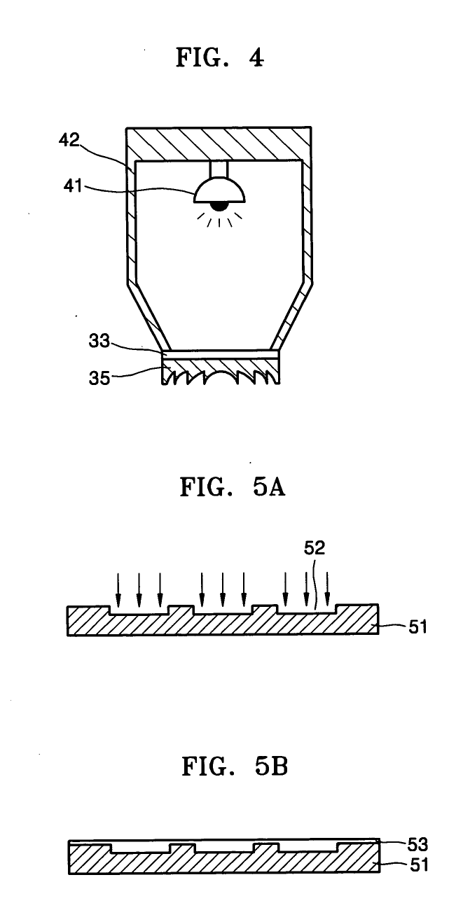

A process of fabricating a single diffractive lens mold for the manufacture of a diffractive lens array mold according to the present invention will now be described with references to FIGS. 3A-3D.

First, as shown in FIG. 3A, precise patterning is performed with EBL to fabricate a master mold 31 with a diffractive lens pattern, i.e., an inverted profile of a unit diffractive lens of a desired diffractive lens array. Referring to FIG. 3B, the master mold 31 is then replicated to produce a single Ni shim 32. A UV embossing technique is used to form a single diffractive lens mold from the single Ni shim 32.

Referring to FIG. 3C, a first UV curable polymer 34 is applied thinly on a transparent film 33. For example, spin coating may be used to coat the UV curable polymer 34 to a thickness greater than a thickness of the desired diffractive lens. Then, the single Ni shim 32 is pressed onto the first UV curable polymer 34. Thus, the first UV curable polymer 34 exhibits a diffractive lens pattern that is an inverted profile of the single Ni shim 32. This step can be performed in a vacuum chamber to prevent the occurrence of bubbles due to air inclusion between the single Ni shim 32 and the first UV curable polymer 34. After the single Ni shim 32 is pressed onto the first UV curable polymer 34, the transparent film 33 is irradiated with UV light to cure the first UV curable polymer 34. In addition, the transparent film 33 is heated to a predetermined temperature to completely cure the first UV curable polymer 34. To improve the adhesion between the transparent film 33 and the first UV curable polymer 34, this process may further include an aging process that will be performed at room temperature when needed. After the aging process, the first UV curable polymer 34 becomes a single diffractive lens mold 35. As shown in FIG. 3D, the single diffractive lens mold 35 is separated from the single Ni shim 32. In this process, a Ni shim having an array pattern (e.g., 3×3 or 5×5) can be used to increase mass productivity. Using this Ni shim, a diffractive lens mold having an array pattern can be made.

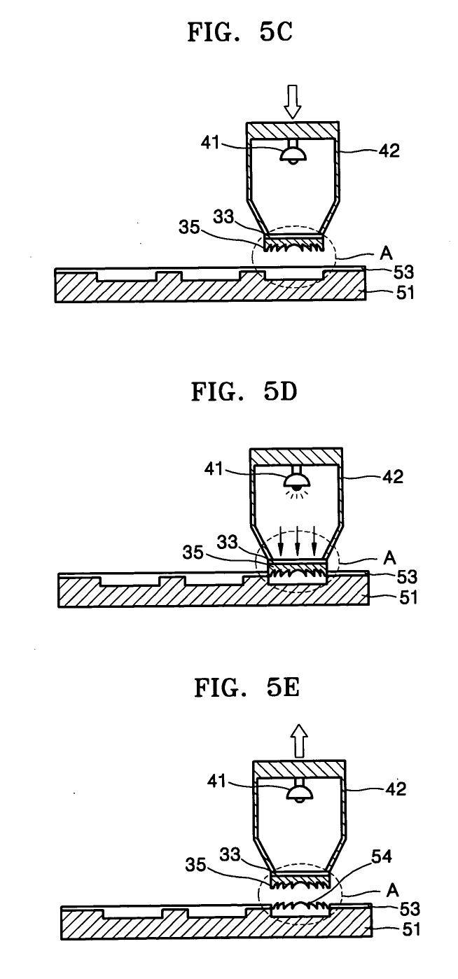

The single diffractive lens mold (or array diffractive lens mold) 35 fabricated in the same manner as shown in FIGS. 3A-3D assumes the same pattern as a unit diffractive lens of a diffractive lens array mold according to the present invention. To fabricate a diffractive lens array mold using the single diffractive lens mold, the present invention provides a UV dispenser including the single diffractive lens array 35. Referring to FIG. 4, a UV light source 41 is disposed within a UV-resistant closed cover 42 containing a housing with a UV-blocking closed structure. The UV-resistant closed cover 42 has an opening at the bottom into which the single diffractive lens mold 35 shown in FIG. 3D is mounted. Thus, UV light emitted by the UV light source 41 is discharged only through the transparent film 33 and the single diffractive lens mold 35. The UV dispenser is operated by X-, Y-, and Z-precision jigs to enable precise movement in the horizontal and vertical directions. The UV dispenser is also designed such that UV light can irradiate only the bottom of the UV-resistant closed cover 42 on which the single diffractive lens mold 35 is mounted, thereby allowing operation with an automation system.

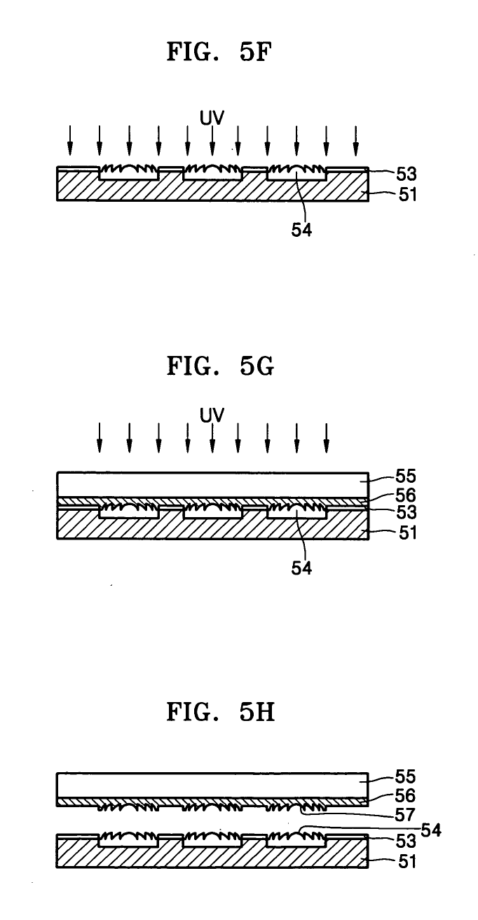

A process of fabricating a diffractive lens array mold with the UV dispenser constructed shown in FIG. 4 according to an embodiment of the present invention will now be described with reference to FIGS. 5A-5H.

Referring to FIG. 5A, predetermined portions of a Si substrate 51 are etched by reactive ion etching (RIE) to form a plurality of grooves 52. Each of the plurality of grooves 52 is precisely etched according to the number and size of unit diffractive lenses contained in a desired diffractive lens array to a depth similar to or greater than the thickness of a desired diffractive lens.

Next, as shown in FIG. 5B, a second UV curable polymer 53 is spin-coated over the Si substrate 51. As shown in FIG. 5C, the single diffractive lens mold 35 is then pressed onto the spin-coated second UV curable polymer 53 using the UV dispenser. In this case, the single diffractive lens mold 35 is pressed onto positions of the Si substrate 51 where the plurality of grooves 52 have been formed. This step can be performed in a vacuum chamber to prevent the occurrence of bubbles due to air inclusion between the single diffractive lens mold 35 and the second UV curable polymer 53.

Referring to FIG. 5D, after having been pressed with the single diffractive lens mold 35 in this manner, the second UV curable polymer 53 is irradiated with UV light from the UV light source 41. Since the UV dispenser has a UV-resistant closed structure on its top, right, and left sides, the UV light emitted from the UV light source 41 exits only through the single diffractive lens mold 35. Thus, a portion of the second UV curable polymer 53 cured by the UV light emitted by the UV dispenser corresponds to a region A pressed by the single diffractive lens mold 35. As shown in FIG. 5E, after UV irradiation, the second UV curable polymer 53 is separated from the UV dispenser. This step is repeatedly performed on portions of the second UV curable polymer 53 on the Si substrate 51 where the plurality of grooves 52 has been formed. As a result, the portions of the second UV curable polymer 53 are cured in the form of a diffractive lens.

As shown in FIG. 5F, this fabrication process may further include the step of irradiating the entire second UV curable polymer 53 including uncured portions between the grooves 52 of the Si substrate 51 with UV light. To improve adhesion between the Si substrate 51 and the second UV curable polymer 53 having the structure of a diffractive lens array, the second UV curable polymer 53 is heated to a predetermined temperature to cure the same and then an aging process is performed at room temperature, thereby completing a first diffractive lens array mold 54.

Referring to FIG. 5G, to form a final diffractive lens array mold, a third UV curable polymer 56 is applied thinly on a transparent film 55 by spin coating and then pressed with the first diffractive lens array mold 54. Thus, the third UV curable polymer 56 has an inverted profile of the first diffractive lens array mold 54. This step can be carried out in a vacuum chamber to prevent occurrence of bubbles due to air inclusion between the third UV curable polymer 56 and the first diffractive lens array mold 54. After having been pressed by the first diffractive lens array mold 54, the transparent film 55 is irradiated with UV light to cure the third UV curable polymer 56. Subsequently, as shown in FIG. 5H, the third UV curable polymer 56 is separated from the diffractive lens array mold 54. To improve adhesion between the transparent film 55 and the third UV curable polymer 56, the transparent film 55 may be heated to a predetermined temperature to further cure the third UV curable polymer 56, followed by an aging process at room temperature.

With the above process, a final second diffractive lens array mold 57 can be fabricated. Pressing the first diffractive lens array mold 54 onto the third UV curable polymer 56, irradiating the same with UV light, and separating them from each other makes it possible to prevent transverse shrinkage. By precisely adjusting an etching process for forming the grooves 52 on the Si substrate 51 and a process for pressing the UV dispenser onto the second UV curable polymer 53, it is possible to minimize alignment error between unit diffractive lenses contained in a diffractive lens array.

Materials of the first through third UV curable polymers 34, 53, and 56 used to fabricate a diffractive lens array mold according to the present invention preferably meet the following requirements. The first UV curable polymer 34 should exhibit excellent adhesion to a thin film, UV curing performance, and light transmittance. After having been cured, the first UV curable polymer 34 should no longer be reactive subsequent to UV irradiation. In addition, the first UV curable polymer 34 should not adhere to the second UV curable polymer 53, thus enabling easy attachment and removal.

The second UV curable polymer 53 should exhibit excellent adhesion to the Si substrate 51 and be capable of being easily cured by UV radiation. After UV curing, the second UV curable polymer 53 should have low adhesion to the first and third UV curable polymers 34 and 56, thus allowing easy separation.

The third UV curable polymer 56 should exhibit excellent adhesion to a thin film and be capable of being easily be cured by UV radiation. Once having been cured, the third UV curable polymer 56 should no longer be reactive subsequent to UV irradiation as well as having excellent light transmittance. The third UV curable polymer 56 may be made from the same material as the first UV curable polymer 34.

A method of fabricating a diffractive lens array mold and a diffractive lens array fabricated using the same offer the following advantages. First, the diffractive lens array is precisely fabricated by a UV embossing process, thereby allowing replication of a micro optical element with a desired structure.

Second, a polymer having excellent adhesion is applied thinly on a thin film and then cured, thereby preventing transverse shrinkage that typically occurs.

Third, the UV dispenser can be precisely adjusted so as to minimize an alignment error between unit diffractive lenses in a diffractive lens array.

Fourth, the fabrication process is performed by the UV dispenser for each diffractive lens contained in a diffractive lens array, thus significantly reducing processing time as compared to a conventional process of fabricating and arranging a plurality of Ni shims. Fifth, the prevent invention is capable of extremely precise alignment when manufacturing a hybrid lens array containing a refractive lens array and a diffractive lens array, thereby providing a diffractive lens array having excellent optical performance.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A method of fabricating a diffractive lens array mold, comprising:
fabricating a single or array diffractive lens mold using a nickel (Ni) shim;
fabricating a first diffractive lens array mold using an ultraviolet (UV) dispenser including the single or array diffractive lens mold; and
fabricating a second diffractive lens array mold having an inverted profile of the first diffractive lens array mold.

2. The method as claimed in claim 1, wherein the fabrication of the singe or array diffractive lens mold comprises:
fabricating a master mold having a micropattern and an inverted profile of a diffractive lens by electron beam lithography;
performing a Ni electroplating process on the master mold and forming a Ni shim having a diffractive lens pattern; and
fabricating a single or array diffractive lens mold having an inverted profile of the Ni shim.

3. The method as claimed in claim 2, wherein the fabrication of the single or array diffractive lens mold comprises:
applying a first UV curable polymer on a transparent film;
pressing the Ni shim onto the first UV curable polymer; and
irradiating the transparent film with UV light to cure the first UV curable polymer, separating the first UV curable polymer from the Ni shim, and forming the single or array diffractive lens mold.

4. The method as claimed in claim 3, further comprising heating the single or array diffractive lens mold to a predetermined temperature and performing an aging process at room temperature to promote adhesion between the single or array diffractive lens mold and the transparent film.

5. The method as claimed in claim 3, which comprises applying the first UV curable polymer over the transparent film by spin coating.

6. The method as claimed in claim 2, wherein fabrication of the first diffractive lens array mold comprises:
etching a surface of a Si substrate to form a plurality of grooves having a predetermined depth;
applying a second UV curable polymer over the Si substrate; and
pressing the UV dispenser including the single or array diffractive lens mold onto each of the plurality of grooves on the Si substrate, irradiating to cure the second UV curable polymer, and forming the first diffractive lens array mold.

7. The method as claimed in claim 6, which comprises applying the second UV curable polymer over the Si substrate by spin coating.

8. The method as claimed in claim 6, wherein the UV dispenser comprises:
a UV resistant closed cover having an opening at a bottom and a UV-blocking housing on top, right, and left sides thereof;
a UV light source disposed in an upper portion of the UV resistant closed cover; and
a single or array diffractive lens mold mounted in the opening at the bottom of the UV resistant closed cover.

9. The method as claimed in claim 6, further comprising heating the first diffractive lens array mold to a predetermined temperature and performing an aging process at room temperature to promote adhesion between the Si substrate and the first diffractive lens array mold.

10. The method as claimed in claim 1, wherein the fabrication of the second diffractive lens array mold comprises:
applying a third UV curable polymer on a transparent plate; and
pressing the first diffractive lens array mold onto the third UV curable polymer, irradiating to cure the third UV curable polymer, and forming the second diffractive lens array mold.

11. The method as claimed in claim 10, which comprises applying the third UV curable polymer over the transparent film by spin coating.

12. The method as claimed in claim 10, further comprising heating the second diffractive lens array mold to a predetermined temperature and performing an aging process at room temperature to promote adhesion between the transparent film and the second diffractive lens array mold.

13. An ultraviolet (UV) dispenser for use in a UV embossing process, the UV dispenser comprising:
a UV resistant closed cover having an opening at a bottom and a UV-blocking housing on top, right, and left sides thereof;
a UV light source disposed in an upper portion of the UV resistant closed cover; and
a single or array diffractive lens mold mounted in the opening at the bottom of the UV resistant closed cover.
